(19) United States
(12) Patent Application Publication
(10) Pub. No.: US 2017/0325003 A1
(43) Pub. Date: Nov. 9, 2017

(54) A VIDEO SIGNAL CAPTION SYSTEM AND METHOD FOR ADVERTISING

(71) Applicant: MPORIUM GROUP PLC, London (GB)

(72) Inventors: Christopher Hackett, Manchester (GB); Tom Smith, London (GB); Nicholas Fish, Darwen (GB); David Carlson, Manchester (GB); Joshua Hornby, Manchester (GB)

(21) Appl. No.: 15/524,763

(22) PCT Filed: Nov. 9, 2015
(86) PCT No.: PCT/GB2015/053383

§ 371 Date: May 5, 2017

(30) Foreign Application Priority Data
Nov. 7, 2014 (GB) 1419834.5

(51) Int. Cl. H04N 21/81; H04N 21/278; H04N 21/234; H04N 21/235; H04N 21/488; H04N 21/44

(52) U.S. Cl. CPC H04N 21/812; H04N 21/4884; H04N 21/44008; H04N 21/23418; H04N 21/2353; H04N 21/278

(57) ABSTRACT

A video signal caption system is described, which includes a receiver for receiving video signals, and a computer configured to process, at least, caption data included with the video signals, including storing a plurality of caption information corresponding to portions of the caption data in a database, detecting when received video signals contain one or more portions of caption data which correspond to caption information stored in the database, and communicating that a detection has been made.

### FIELD

This invention relates to a video signal caption system and method and, particularly, but not exclusively, a video signal caption system and method for advertising.

### BACKGROUND

Current interactive advertising systems, that is, advertising systems which tailor the advertisement shown in some manner, typically rely on data which describes, in some way, metrics related to the viewer of the advertisement. For example, online advertisements may have access to the search history of a user and, therefore, show advertisements related to that search history. In a similar manner, the location of a user could be used to show advertisements from local businesses in the surrounding area.

It is not admitted that any of the information in this patent specification is common general knowledge, or that the person skilled in the art could be reasonably expected to ascertain or understand it, regard it as relevant or combine it in any way at the priority date.

### SUMMARY

In a first aspect of the present invention, there is provided a video signal caption system including:
a receiver for receiving video signals; and
a computer configured to process, at least, caption data included with the video signals, including:
   storing a plurality of caption information corresponding to portions of the caption data in a database;
   enabling the caption information to be further associated with one or more descriptors relating to the video signals the caption information is associated with;
   detecting when received video signals contain one or more portions of caption data which correspond to caption information stored in the database; and
   communicating that a detection has been made and providing at least one descriptor relating to the video signals associated with the detection.

In a second aspect of the present invention, there is provided a video signal caption method including the steps of:
receiving video signals; and
processing, at least, caption data included with the video signals, including:
   storing a plurality of caption information corresponding to portions of the caption data in a database;
   enabling the caption information to be further associated with one or more descriptors relating to the video signals the caption information is associated with;
   detecting when received video signals contain one or more portions of caption data which correspond to caption information stored in the database; and
   communicating that a detection has been made and providing at least one descriptor relating to the video signals associated with the detection.

In at least one embodiment, the video signal is a television broadcast signal, such as a terrestrial television signal, a satellite television signal, a cable television signal or an internet television/video signal.

In at least one embodiment, the caption data is closed captions and/or open captions.

In at least one embodiment, one or more portions of the caption data are inputted to a hash function to generate a hash code, the hash code included in the caption information stored in the database.

In at least one embodiment, detection when one or more portions of caption data match one or more portions of caption data stored in the database includes comparing hash codes of one or more portions of caption data from the video signals with the hash codes stored in the database.

In at least one embodiment, caption data transmitted in relation to the video signal is transmitted as a plurality of caption frames. Furthermore, data relating to each caption frame is stored in the database.

In at least one embodiment, caption information that can be stored includes: the next caption frame, the previous caption frame, the channel of broadcast, time stamp (or relative offset), the or each descriptor.

In at least one embodiment, the method and/or system includes an advertising server and communication of a detection is made to the advertising server. The advertising server then selects advertisements to display based on the or each descriptor received.

In at least one embodiment, the method and/or system includes a content optimization server and communication of a detection is made to the content optimization server. The content optimization server then selects content to display on a user's webpage, search facility or other user interface based on the or each descriptor received.

In at least one embodiment, the selected advertisements are displayed on electronic devices.

In a third aspect of the present invention, there is provided an advertising system including:
a receiver for receiving video signals;
a caption server configured to process, at least, caption data included with the video signals, including:
   storing a plurality of caption information corresponding to portions of the caption data in a database;
   enabling the caption information to be further associated with one or more descriptors relating to the video signals the caption information is associated with;
   detecting when received video signals contain one or more portions of caption data which correspond to caption information stored in the database; and
   communicating that a detection has been made and providing at least one descriptor relating to the video signals associated with the detection;
an advertising server having a plurality of advertisements for display configured to receive detections from the caption server and, when a detection is received, selecting and configuring to display one or more advertisements based on the, or at least one of, the descriptors.

In a fourth aspect of the present invention, there is provided an advertising method including the steps of:
receiving video signals; and
processing, at least, caption data included with the video signals, including:
   storing a plurality of caption information corresponding to portions of the caption data in a database;
   enabling the caption information to be further associated with one or more descriptors relating to the video signals the caption information is associated with;
   detecting when received video signals contain one or more portions of caption data which correspond to caption information stored in the database; and
   communicating that a detection has been made and providing at least one descriptor relating to the video signals associated with the detection;
   selecting and configuring to display one or more advertisements based on the, or at least one of, the descriptors.

Further aspects of the present invention include:

A video signal caption system including a receiver for receiving video signals, and a computer configured to process, at least, caption data included with the video signals, including:
storing a plurality of caption information corresponding to portions of the caption data in a database;
detecting when received video signals contain one or more portions of caption data which correspond to caption information stored in the database; and
communicating that a detection has been made.

A video signal caption method including the steps of receiving video signals, and processing, at least, caption data included with the video signals, including:
storing a plurality of caption information corresponding to portions of the caption data in a database;
detecting when received video signals contain one or more portions of caption data which correspond to caption information stored in the database; and
communicating that a detection has been made.

An advertising system including a receiver for receiving video signals and a caption server configured to process, at least, caption data included with the video signals, including:
storing a plurality of caption information corresponding to portions of the caption data in a database;
detecting when received video signals contain one or more portions of caption data which correspond to caption information stored in the database; and
communicating that a detection has been made;
an advertising server having a plurality of advertisements for display configured to receive detections from the caption server and, when a detection is received, selecting and configuring to display one or more advertisements.

An advertising method including the steps of receiving video signals, and processing, at least, caption data included with the video signals, including:
storing a plurality of caption information corresponding to portions of the caption data in a database;
detecting when received video signals contain one or more portions of caption data which correspond to caption information stored in the database; and
communicating that a detection has been made;
selecting and configuring to display one or more advertisements.

### BRIEF DESCRIPTION OF DRAWINGS

An embodiment of the apparatus will now be described by way of example only with reference to the accompanying drawings in which:

FIG. 1 is a schematic diagram of one embodiment of a video signal caption system;

FIG. 2 is a schematic view of a video signal, caption frames and hash codes according to one embodiment of the invention;

FIG. 3 is a schematic view of a group of caption frames and hash codes according to one embodiment of the invention;

FIG. 4 is a schematic view of a group of caption frames and hash codes and a corresponding matching group according to one embodiment of the invention;

FIG. 5 is a schematic view of a group of caption frames and hash codes, a corresponding matching group and a second corresponding matching group according to one embodiment of the invention; and

FIG. 6 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized in conjunction with embodiments of the present invention.

### DESCRIPTION OF EMBODIMENTS

The following examples are intended to illustrate the scope of the invention and to enable reproduction and comparison. They are not intended to limit the scope of the disclosure in any way.

Captioning of video footage is common in the television and movie industry and, generally, provides a textual readout overlaid on the display screen to enable the viewer to read dialogue, or other narrative, related to the video. Captioning can be used to provide people who cannot hear the audio output from the video stream with the narrative or to provide people who cannot understand the language of the audio output with a narrative in a language that they can understand.

Traditionally, captioning of video footage has been termed “subtitles” but is also known as “closed captioning” (often abbreviated as “CC”), where the captioning is only displayed when requested, and option captioning, where the captioning is displayed at all times. In some countries, the term “subtitles” tend to be more specifically understood to be text displayed as a translation of the spoken language in the video footage and closed captioning as text displayed on request when a viewer or viewers cannot listen to the audio for any reason. In other countries, the term “subtitles” is used more ubiquitously as representing any situation where text is outputted for reading in conjunction with video footage. For the remainder of this description, the term “captioning” will be used ubiquitously to represent subtitles, closed captioning and open captioning relating to video footage.

Captions can be embedded in a video stream. Prior to digital formats, this was performed by encoding data into a non-viewable line of the composite video signal, typically, line 21. The video receiver then extracts the information as text from line 21, if captions are turned on, and displays the corresponding textual data overlaid on top of the video signal. Digital video signals have the ability to have the captions encoded as image data, that is, the captions are encoded in the signal as an image and the decoded image is overlaid on the video signal, if captions are enabled.

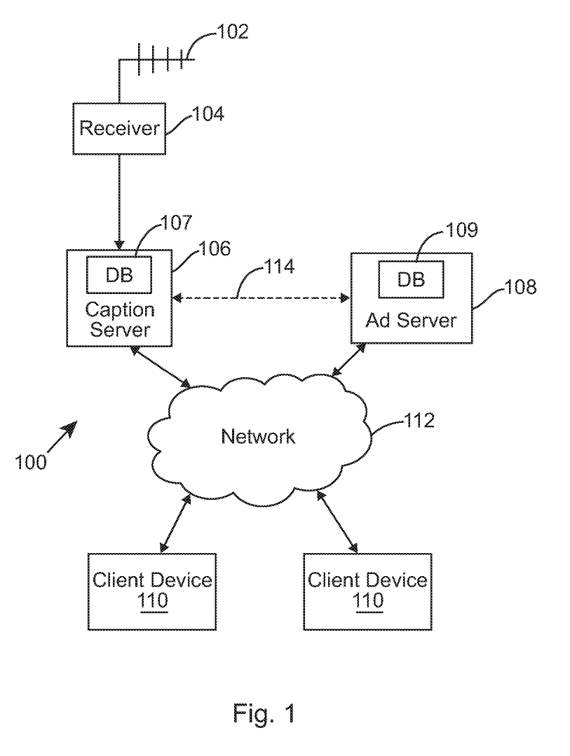

Referring to FIG. 1, an exemplary system 100 is shown within which the present invention may be embodied. The system 100 includes an aerial 102, receiver 104, computer system 106, which is in the form of a caption server 106, advertising server 108 and client devices 110. The caption server 106, advertising server 108 and client devices 110 being connected together using a network 112, such as the internet.

Receiver 104 receives video signals transmitted wirelessly via aerial 102. The video signals represent a plurality of video channels, one or more of the channels including captions. The receiver 104 extracts information from the video signals including the caption data, which is, typically, provided as caption ‘frames’, which include data such as the actual caption representation, the video channel and timing information for when the caption should be shown in relation to the video signal.

The extracted information is provided to the caption server 106 and some, or all, of the extracted information is used to generate a ‘hash’ code for that frame.

A hash code, in the context of this specification, is a code generated by a function which takes some form of input data, usually of a textual nature but can also be non-textual nature, and generates a code which is highly likely to be unique, even if the input data is extremely similar. Often, hash codes are extremely difficult to reverse into the original input data, without some prior knowledge of the inputs to the function and are, therefore, used for cryptographic purposes, but this is not necessarily a requirement for the function used to generate a hash code in the context of this specification. Common cryptographic hash functions include the message-digest algorithm series, of which “MD5” is the most well-known, and the Secure Hash Algorithm (SHA) series. Non-cryptographic hash functions, of which some functions can be classed as “checksums”, include the BSD checksum algorithm (implemented by the UNIX ‘sum’ function) and CityHash developed by Google®.

The caption server 106 includes a database and the caption server 106 checks whether the ‘hash’ code for a particular frame, or, in some cases, series of frames, already exists in the database. If not, the hash code and some or all of the extracted information is stored in the database. In addition, a reference to related frame or frames is included in the information stored in the database. For example, a single frame may have the hash code, extracted information and a reference to the database entry for the previous frame and next frame stored as a particular record in the database.

A series of record entries in the database, representing consecutive caption frames, can be “tagged” with a descriptor or descriptors, or otherwise grouped, to indicate that those frames are in some way related. For example, consecutive caption frames which represent an advertisement for a particular product can be tagged to indicate that those frames are an advertisement of that particular product and may be further categorized to indicate the field of the product. For example, record entries which are related to a video advertisement for a particular motorcar could be tagged with the name of the manufacturer, the brand of the car, the target market (luxury, city runabout, 4WD, etc.), locations the car is sold, etc.

Whilst this embodiment uses “tags” as descriptors, any taxonomy or categorization can be used as such descriptors.

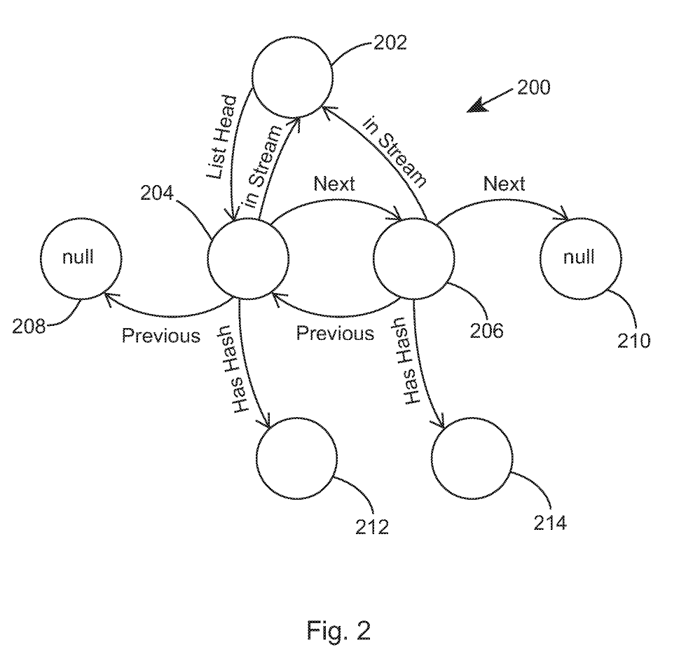

Further details regarding the entry and matching of records in the database are provided with reference to FIGS. 2, 3, 4, 5 and 6 below.

When a hash code, or series of hash codes, matches a record or records in the database 107 and that match has associated tags (descriptors), the caption server 106 indicates a match and the tags that are associated with the match. In this example, the communication of the match and the associated tags are received by advertising server 108. Advertising server 108 controls the display of advertisements to a plurality of electronic devices via network 112. Advertising server 108 includes an advertising database or store 109 which includes a plurality of adverts. The advertising server 108, once it has received an indication that a match is found, can decide to select one or more adverts from the advertising database 109 based on the tags associated with the match. Adverts that are selected are then shown on one or more of the electronic devices for which the advertising server 108 is controlling the display of advertisements.

In this manner, adverts being displayed on one or more electronic devices can be specifically targeted to correspond to the display of particular video on a video channel. For example, a detected television advertisement for a particular motorcar can be “targeted” such that adverts for competing models of motorcars are shown on electronic devices when the detected television advertisements is shown. Or, when a particular television program is shown and it is detected that a character in the program is using a particular product, advertisements can be targeted to show corresponding products.

Referring now to FIGS. 2, 3, 4 and 5, the process of entering captions into the database 107 and matching captions from subsequent video signals will be described in more detail.

A representation of processing of an incoming video signal according to one embodiment is shown generally at 200. The process 200 includes a video signal or stream 202. Within the video signal 202 are a plurality of caption frames. For clarity, only two caption frames 204, 206 are shown, although it should be understood that several caption frames would be present in any video containing captions. Also shown are a start node 208 and end node 210, representing the start and end of the series of caption frames for this particular video signal 202. For each caption frame, a hash code 212, 214 is generated.

Assuming that no data relating to caption information is currently stored in the database 107, the caption server 106 processes the caption information by storing, for each caption frame, the generated hash code and a reference to the previous caption frame and the next caption frame. Optionally, additional information can also be stored.

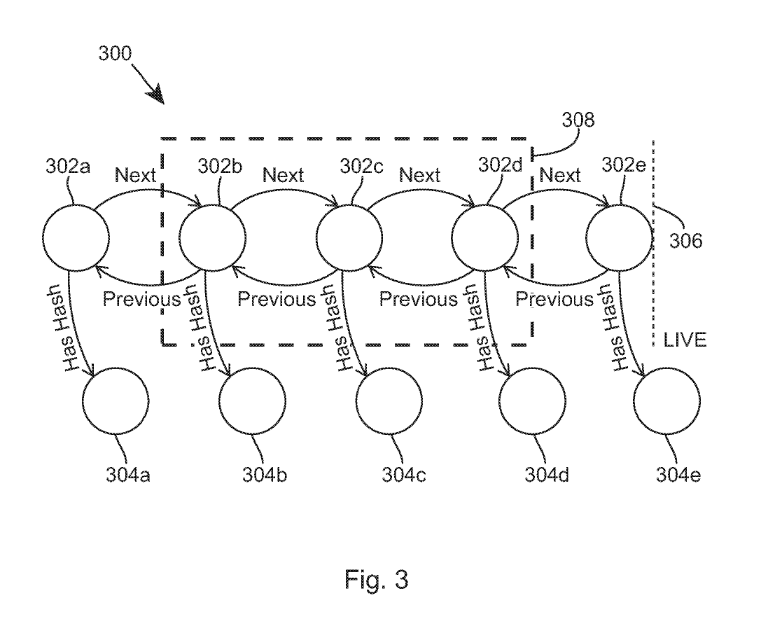

Referring to FIG. 3, an expanded view of a ‘chain’ of caption frames 300, is shown, representing a ‘live’ video signal. As in FIG. 2, each caption frame 302a-302e has a corresponding hash code 304a-304e and the ‘live’ point in the video signal is represented by live indicator 306. In this case, as in FIG. 2, none of the caption frames have been previously stored in the database 107, and, therefore, each frame is processed as described in FIG. 2. A frame group 308, represents a group of caption frames of particular interest, being caption frames 302b, 302c and 302d, which will be discussed below.

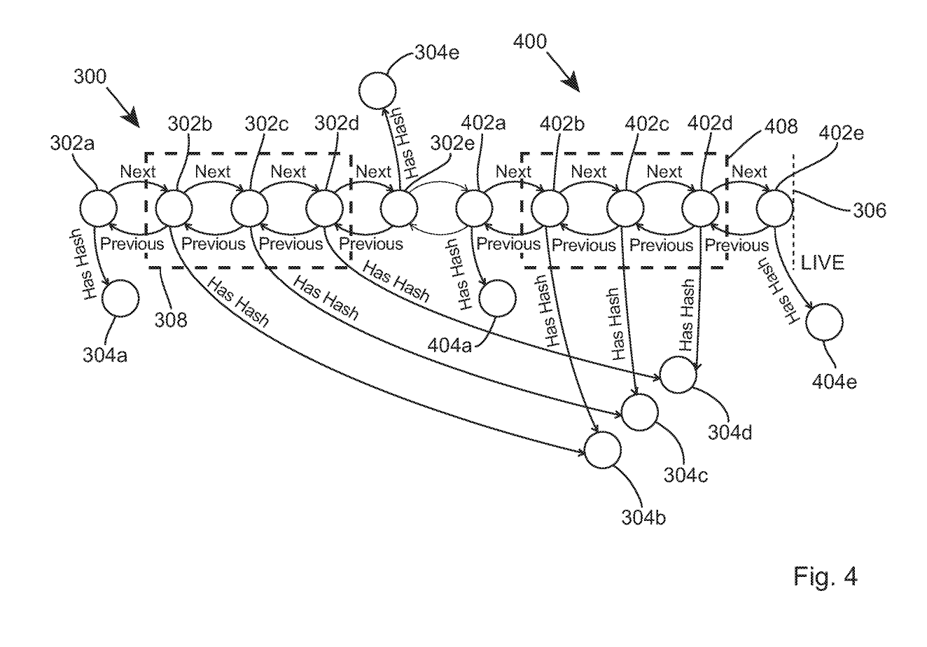

Referring now to FIG. 4, the chain of caption frames 300 from FIG. 3 is shown along with, at a later point in time, a second chain of caption frames 400. The second chain 400 having caption frames 402a-402e. When the caption server 106 processes the second chain 400, hash codes 404a and 404e, corresponding to caption frames 402a and 402e, are unique compared to the first chain 300 but the hash codes generated from caption frames 402b, 402c and 402d are found to be the same as 304b, 304c and 304d. That is, the frame group 308 matches a later frame group 408.

In this exemplary embodiment, the frame group 308 and frame group 408 represent the first time that this particular match has occurred. Caption server 106 adds the hash codes 304b, 304c and 304d, and its corresponding video signal, and any further matches it finds, to a list of matches for further processing. The list of matches is then processed to add appropriate tags. The tags can be added automatically, through the analysis of the actual content of the captions, or added by a human administrator. Regardless of how the tags are added, each match is only required to be processed once. That is, the hash group, and ultimately, the corresponding caption frames, are given keywords or tags, or otherwise entered into a taxonomy, which describes the content of the video signal that the caption frames correspond to.

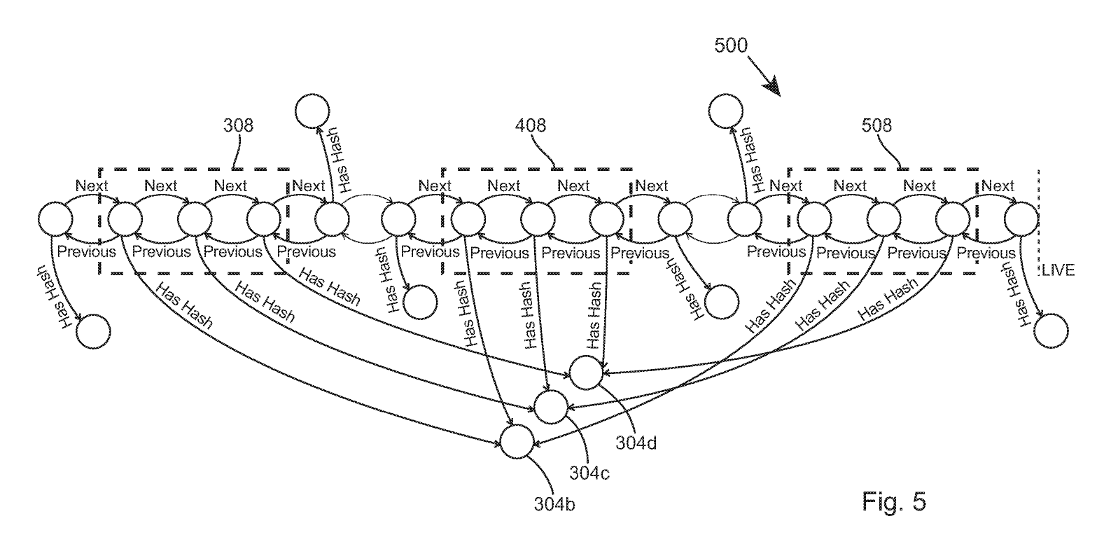

Moving on to FIG. 5, frame groups 308 and 408 are shown and, accordingly, tags have been added in respect of hash codes 304b, 304c and 304d. At a later point in time, frame group 508 is found to have hash codes which match hash codes 304b, 304c and 304d, indicating that the same captions are being broadcast with a particular video signal, which may represent a different channel than when the hash codes 304b, 304c and 304d were originally detected. As there are already tags associated with these hash codes, the caption server 106 indicates a match and communicates the match and the relevant tags to any subscribers. As described in relation to FIG. 1, one subscriber may be an advertising server 108, which then, broadcasts advertisements to electronic devices which have been pre-defined to be triggered by certain tags being contained in a match.

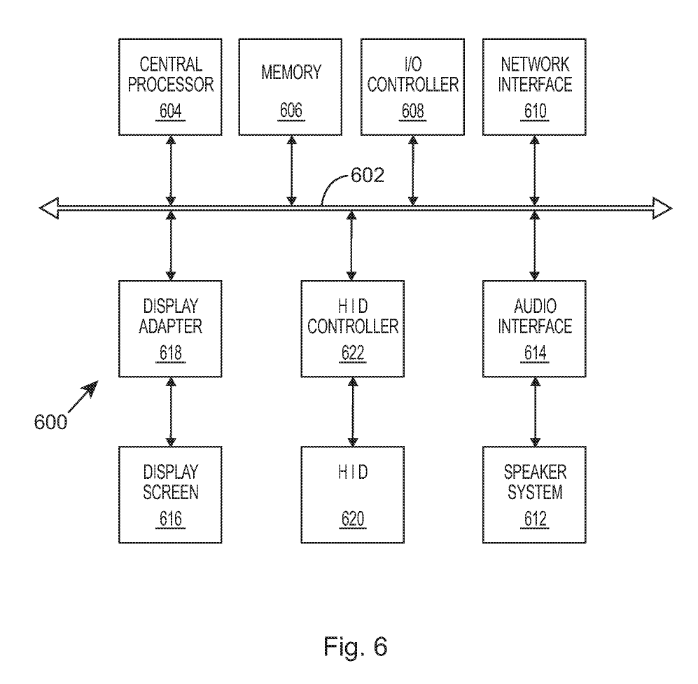

FIG. 6 depicts a block diagram of computer system 600 suitable for implementing servers 106, 108 or clients 110. Computer system 600 includes bus 602 which interconnects major subsystems of computer system 600, such as central processor 604, memory 606 (typically RAM, but which may also include ROM, flash RAM, or the like), input/output controller 608, network interface 610, audio device, such as speaker system 612 via audio output interface 614, display screen 616 via display adapter 618 and a Human Interface Device (HID) 620 via HID Controller 622.

Bus 602 allows data communication between central processor 604 and system memory 606, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS) which controls basic hardware operation such as interaction with peripheral components. Applications resident with computer system 600 are generally stored on and accessed via computer readable media, such as hard disk drives, optical drives or other storage medium. Additionally, applications may be in the form of electronic signals modulated in accordance with the application and data communication technology when accessed via network interface 610 or other telecommunications equipment (not shown).

Network interface 610 may provide direct connection to remote servers via direct network link to the Internet via a POP (point of presence). Network interface 610 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 6 need not be present to practice the present disclosure. Devices and subsystems may be interconnected in different ways from that shown in FIG. 6. Operation of a computer system such as that shown in FIG. 6 is readily known in the art and is not discussed in detail in this application. Software source and/or object codes to implement the present disclosure may be stored in computer-readable storage media such as one or more of system memory 604, fixed disk, optical disk or accessed via network interface 610. The operating system provided on computer system 600 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), or other known or developed operating system. In some embodiments, computer system 600 may take the form of a tablet computer or other electronic device, such as a “smartphone” or smart television, amongst other examples. In mobile, low power and entertainment computer alternative embodiments, the operating system may be iOS® (iOS is a registered trademark of Cisco Systems, Inc. of San Jose, Calif., used under license by Apple Corporation of Cupertino, Calif.), Android® (Android is a trademark of Google Inc. of Mountain View, Calif.), Blackberry® Tablet OS (Blackberry is a registered trademark of Research In Motion of Waterloo, Ontario, Canada), webOS (webOS is a trademark of Hewlett-Packard Development Company, L.P. of Texas), and/or other suitable operating systems.

The detailed descriptions of this disclosure are presented in part in terms of algorithms and symbolic representations of operations on data bits within a computer memory representing alphanumeric characters or other information. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of embodiments of the present invention; the operations are machine operations. Useful machines for performing the operations of one or more embodiments of the present invention include general purpose digital computers or other similar devices. In all cases the distinction between the method operations in operating a computer and the method of computation itself should be recognized. One or more embodiments of present invention relate to methods and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

Some embodiments of the present invention also relate to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipment through signals configured to particular protocols which may or may not require specific hardware or programming to interact. In particular, various general purpose machines may be used with programs written in accordance with the teachings herein, or it may prove more convenient to construct more specialized apparatus to perform the required method steps. The required structure for a variety of these machines will appear from the description below.

In this description, several terms which are used frequently have specialized meanings in the present context.

The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis. A “module” refers to a portion of a computer system and/or software program that carries out one or more specific functions and may be used alone or combined with other modules of the same system or program.

The term “desktop” means a specific user interface which presents a menu or display of objects with associated settings for the user associated with the desktop. When the desktop accesses a network resource, which typically requires an application program to execute on the remote server, the desktop calls an Application Program Interface, or “API”, to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a world wide network of computers, namely the “World Wide Web” or simply the “Web”. Examples of Browsers compatible with one or more embodiments of the present invention include the Chrome browser program developed by Google Inc. of Mountain View, Calif. (Chrome is a trademark of Google Inc.), the Safari browser program developed by Apple Inc. of Cupertino, Calif. (Safari is a registered trademark of Apple Inc.), Internet Explorer program developed by Microsoft Corporation (Internet Explorer is a trademark of Microsoft Corporation), the Opera browser program created by Opera Software ASA, or the Firefox browser program distributed by the Mozilla Foundation (Firefox is a registered trademark of the Mozilla Foundation). Although the following description details such operations in terms of a graphic user interface of a Browser, one or more embodiments of the present invention may be practiced with text based interfaces, or even with voice or visually activated interfaces, that have many of the functions of a graphic based Browser.

While the above description refers to one embodiment of a method of providing content and system for providing content, it will be appreciated that other embodiments can be adopted by way of different combinations of features. Such embodiments fall within the spirit and scope of this invention.

An example of one such alternative is making use of the invention in a method of content optimization. In this method, when a hash code, or series of hash codes, matches a record or records in the database and that match has associated tags (descriptors), the caption server indicates a match and the tags that are associated with the match. In this example, the communication of the match and the associated tags are received by a content optimization server instead of or in addition to an advertising server. The content optimization server pre-emptively selects the display of content on a user's webpage, search facility or other user interface based on the or each descriptor received. The content optimization server may include a database or store which includes a reference to a plurality of different media streams or search criteria algorithms which can be selected dependent upon the match. The optimization server, once it has received an indication that a match is found, can decide to select one or more media streams or search suggestions depending upon the content of the database based on the tags associated with the match. Media streams or search suggestions that are selected are then displayed to the user on a selected web page or other platform.

In this manner, content being displayed to a user on one or more electronic devices can be specifically targeted to correspond to the display of particular video on a video channel. For example, a detected television program containing reference to a particular news event can be “optimized” such that appropriate content and/or search suggestions are pre-emptively provided on a user's web page or other platform.

The term “comprises” and its grammatical variants has a meaning that is determined by the context in which it appears. Accordingly, the term should not be interpreted restrictively unless the context dictates so.

1. A video signal caption system including:
a receiver for receiving video signals; and
a caption server configured to process, at least, caption data included with the video signals, including:
storing a plurality of caption information corresponding to portions of the caption data in a database;
detecting when the video signals contain one or more portions of the caption data which correspond to caption information stored in the database; and
communicating that a detection has been made.

2. The video signal caption system according to claim 1, wherein the caption server is configured to associate the caption information with one or more descriptors relating to the video signals the caption information is associated with, and to provide at least one of the descriptors relating to the video signals associated with the detection when communicating that the detection has been made.

3. The video signal caption system according to claim 1, wherein the video signal is a television broadcast signal.

4. The video signal caption system according to claim 1, wherein the caption data is at least one of closed captions and open captions.

5. The video signal caption system according to claim 1, wherein one or more portions of the caption data are inputted to a hash function to generate a hash code, the hash code included in the caption information stored in the database.

6. The video signal caption system according to claim 1, wherein detecting includes comparing hash codes of one or more portions of the caption data from the video signals with hash codes stored in the database, wherein the hash codes stored in the database are caption information corresponding to portions of the caption data.

7. The video signal caption system according to claim 1, wherein caption data included with the video signal is a plurality of caption frames.

8. The video signal caption system according to claim 7, wherein data relating to each caption frame is stored in the database.

9. The video signal caption system according to claim 1, wherein the caption information comprises one or more of: a next caption frame, a previous caption frame, a channel of broadcast, a time stamp, or a relative offset.

10. The video signal caption system according to claim 1, comprising an advertising server, wherein communicating the detection is made to the advertising server and includes the caption data which correspond to caption information stored in the database, and wherein the advertising server is configured to select advertisements to display based on the caption data which correspond to caption information stored in the database, in response to the communicating.

11. The video signal caption system according to claim 1, comprising a content optimization server, wherein communicating the detection is made to the content optimization server and includes the caption data which correspond to caption information stored in the database, and wherein the content optimization server is configured to select content to display on a user's webpage, search facility or other user interface based on the caption data which correspond to caption information stored in the database, in response to the communicating.

12. The video signal caption system according to claim 10, wherein the selected advertisements are displayed on electronic devices.

13. A video signal caption method including the steps of:
receiving video signals; and
processing, at least, caption data included with the video signals, including:
storing a plurality of caption information corresponding to portions of the caption data in a database;
detecting when the video signals contain one or more portions of the caption data which correspond to caption information stored in the database; and
communicating that a detection has been made.

14. The video signal caption method according to claim 13, comprising the steps of:
associating the caption information with one or more descriptors relating to the video signals the caption information is associated with; and
providing at least one descriptor relating to the video signals associated with the detection when communicating that a detection has been made.

15. The video signal caption system according to claim 1, comprising:
an advertising server having a plurality of advertisements for display configured to receive detections from the caption server and, when a detection is received, selecting and configuring to display one or more advertisements.

16. The video signal caption system according to claim 15, wherein
the caption server associates the caption information with one or more descriptors relating to the video signals the caption information is associated with; and provides at least one descriptor relating to the video signals associated with the detection when communicating that the detection has been made; and
the advertising server selects and configures to display the one or more advertisements based on at least one of the descriptors.

17. An advertising method including the steps of:
receiving video signals; and
processing, at least, caption data included with the video signals, including:
storing a plurality of caption information corresponding to portions of the caption data in a database;
detecting when received video signals contain one or more portions of caption data which correspond to caption information stored in the database;
communicating that a detection has been made; and
selecting and configuring to display one or more advertisements.

18. The advertising method according to claim 17, comprising:
associating the caption information with one or more descriptors relating to the video signals the caption information is associated with; and
providing at least one descriptor relating to the video signals associated with the detection when communicating the detection; and
the selecting and configuring is based on at least one of the descriptors.
